(19) United States
(12) Patent Application Publication
(10) Pub. No.: US 2009/0224523 A1
(43) Pub. Date: Sep. 10, 2009

(54) HEATED STEERING WHEEL USING INDUCTION CURRENT

(75) Inventor: Joonmo Park, Hwaseong-si (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/323,347

(22) Filed: Nov. 25, 2008

(30) Foreign Application Priority Data
Mar. 4, 2008 (KR) 10-2008-0019880

(51) Int. Cl. B62D 1/04; B60L 1/02

(52) U.S. Cl. 280/771; 219/204

(57) ABSTRACT

The present invention relates to a heated steering wheel using induction current that includes a ferromagnetic material for generating induction current using the change of a magnetic field caused by supplied alternating current when the alternating current is supplied to a wire that is provided between a main body of the steering wheel and an exterior member surrounding the main body. When alternating current is supplied to a wire, the ferromagnetic material generates induction current using the change of a magnetic field caused by supplied alternating thereby causing the temperature of the steering wheel to increase quickly so that it is possible to improve a driver's operation sensibility of the steering wheel when an outdoor air temperature is low.

### CROSS-REFERENCE TO RELATED APPLICATION

The present application claims priority to Korean Application Number 10-2008-0019880, filed on Mar. 4, 2008, the entire contents of which is incorporated herein for all purposes by this reference.

### BACKGROUND OF THE INVENTION

1. Field of the Invention

The present invention relates to a steering wheel, and more particularly, to a heated steering wheel that includes a ferromagnetic material for generating heat using induction current induced with a magnetic field caused by alternating current supplied to a conducting member that is provided in the steering wheel in order to quickly increase the temperature thereof.

2. Description of Related Art

As shown in FIG. 1, a heating coil 102 of a conventional heated steering wheel is provided between a main body 101a and an exterior member 101b surrounding the main body 101a of a rim portion of a steering wheel. The heating coil generates heat to increase the temperature of rim 101 of the steering wheel. When the outdoor air temperature is low, like in winter, the heating coil steering wheel increases the temperature of the rim portion 101 up to 20° C. in order to improve a driver's operation sensibility of rim 101 of the steering wheel.

However, since the heating rate of heating coil 102 of the conventional heating coil steering wheel is low, approximately 390 seconds are required to raise the temperature to 20° C. from below 0° C. and 270 seconds are required to raise the temperature to 20° C. from 0° C. as shown in FIG. 2. That is, about 4 minutes on average is required until the temperature of rim 101 of the steering wheel reaches 20° C. at which temperature a driver is comfortable. Therefore, until about 4 minutes passes from starting, the driver may not be comfortable due to the low temperature of the steering wheel. In particular, if exterior member 101b surrounding the main body 101a of rim 101 is made of wood instead of leather, much more time is required until the temperature of rim 101 reaches 20° C.

Meanwhile, if the diameter of heating coil 102 provided in the rim 101 of the steering wheel is decreased, the resistivity of heating coil 102 may be increased so that the temperature of rim 101 of the steering wheel can quickly rise. However, in this case, there is a problem in that the life of heating coil 102 is decreased. In addition, it is difficult to uniformly provide a thin heating coil 102 on the surface of cylindrical rim 101 of the steering wheel for uniform, distributed heating.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a heated steering wheel using induction current that includes a conductor for generating induction current using the change of a magnetic field caused by alternating current supplied to a conducting member that is provided at a rim region of a steering wheel to quickly increase the temperature thereof.

According to an aspect of the present invention, a heated steering wheel using induction current includes a main body; an exterior member that surrounds the main body; and a conductor provided between the main body and the exterior member, the conductor configured to generate induction current using the change of a magnetic field caused by alternating current.

The conductor may be composed of a ferromagnetic material. The ferromagnetic material may be metal powder. The conductor may be uniformly provided between the main body and the exterior member. The conductor may be formed in a circular shape along a circumference of the main body. The conductor may be provided along a circumference of the main body other than a region configured to receive a spoke of the steering wheel. The conductor may be formed in a polygonal shape.

In various embodiments, the heated steering wheel further includes a conducting member provided between the main body and the exterior member, the wire being supplied with alternating current. The conducting member may be a wire, such as an electrical wire. The conducting member may be wound around the main body. The wire may be provided between the main body and the exterior member in a similar shape as the main body. The conducting member may be provided adjacent the conductor with a predetermined gap therebetween. The heated steering wheel may include an insulation member that insulates the conducting member from the conductor.

Various aspects of the inventions are directed to a passenger vehicle including a heated steering wheel as defined above.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic view showing a conventional heating coil steering wheel.

FIG. 2 is a temperature graph of the heating coil steering wheel of FIG. 1.

FIG. 3 is a schematic view showing an exemplary heated steering wheel using induction current according to the present invention.

FIG. 4 is a view illustrating the operation of the steering wheel of FIG. 3.

FIGS. 5A to 5C are schematic views showing an exemplary heated steering wheel using induction current according to the present invention.

FIG. 6 is a schematic view showing an exemplary heated steering wheel using induction current according to the present invention.

FIG. 7 is a schematic view showing an exemplary heated steering wheel using induction current according to the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

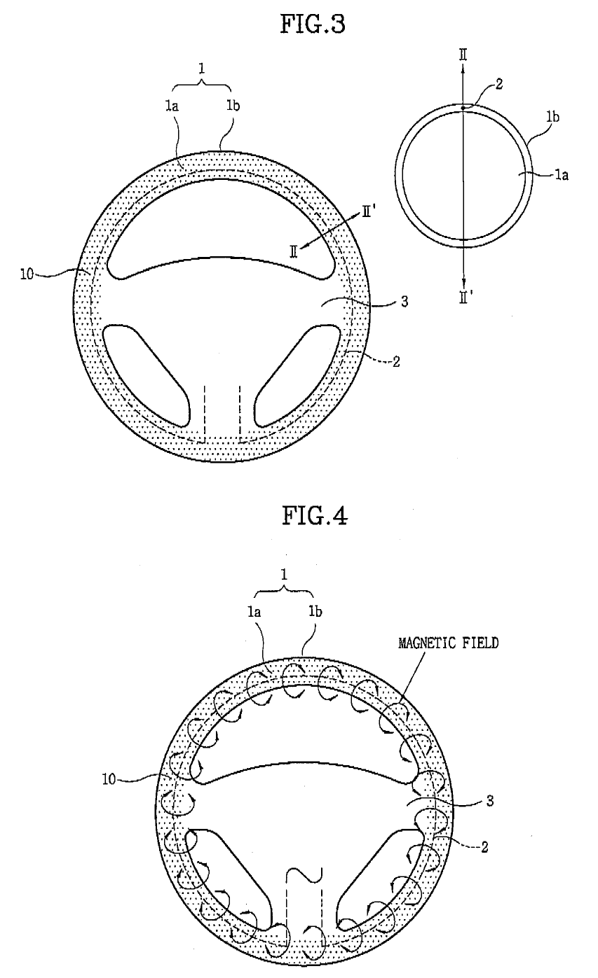

Various embodiments of the present invention will be described hereinafter with reference generally to FIGS. 3 to 7.

Referring to FIG. 3, a heated steering wheel using induction current according to the present invention may include a main body 1a of a rim portion 1 of steering wheel, an exterior member 1b that surrounds main body 1a of rim portion 1, a conducting member 2 supplied with alternating current, and a conductor 10 that is provided substantially close to the conducting member 2 and generates heat with induction current caused by the alternating current supplied to the conducting member 2.

In various aspects of the present invention, the conducting member 2 may be provided between the main body 1a and the exterior member 1b of the steering wheel. The conducting member is supplied with an alternating current. The location of the conducting member 2, however, may not be limited to the location between the main body 1a and the exterior member 1b of the steering wheel if the conducting member 2 can induce an induction current to the conductor 10 by a magnetic field. The conducting member 2 may also be a wire or wire-shaped conductor.

The conductor 10 may be a ferromagnetic material. In various aspects of the present invention, the ferromagnetic material may be metal powder that generates induction current using the change of a magnetic field for heating. Accordingly, when alternating current is supplied to the conducting member 2, a magnetic field is generated around conducting member 2 and an induction current occurs in the ferromagnetic material 10 due to the induced magnetic field as shown FIG. 4. In this case, ferromagnetic material 10 generates induction current using the change of the magnetic field for heating the steering wheel's rim 1.

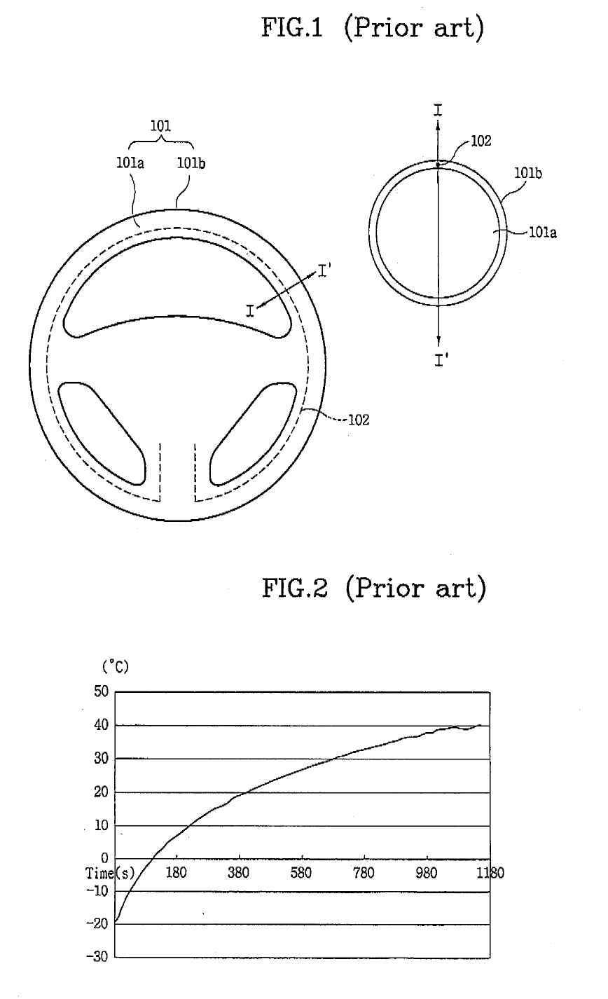

Ferromagnetic material 10 is optionally a metal powder that generates induction current using the change of a magnetic field, and ferromagnetic material 10 emits heat caused by the induction current through the surface thereof. Accordingly, the heated steering wheel using induction current according to the present invention has a larger heating area as compared to conventional heated steering wheels which include only a heating coil (see, e.g., 102 of FIG. 1). Therefore, the heated steering wheel using induction current according to the present invention can more quickly increase the temperature of the steering wheel. As a result, the heated steering wheel of the present invention can improve operation sensibility of the steering wheel when outdoor air temperature is low like in winter.

Further, since the temperature of rim 1 of steering wheel is increased using heat generated from ferromagnetic material 10, heat generation of conducting member 2 incurred by resistivity does not need to be considered in the heated steering wheel using induction current. That is, a conducting member 2 having low resistivity may be used in the heated steering wheel according to the present invention.

Meanwhile, ferromagnetic material 10 may be a metal powder, that is, a conductor. Accordingly, when ferromagnetic material 10 comes in contact with conducting member 2, alternating current may also flow in ferromagnetic material 10. Therefore, the heated steering wheel may further require an insulation member that insulates with conducting member 2 from ferromagnetic material 10 in order to prevent the alternating current, which is supplied to with conducting member 2, from flowing to ferromagnetic material 10.

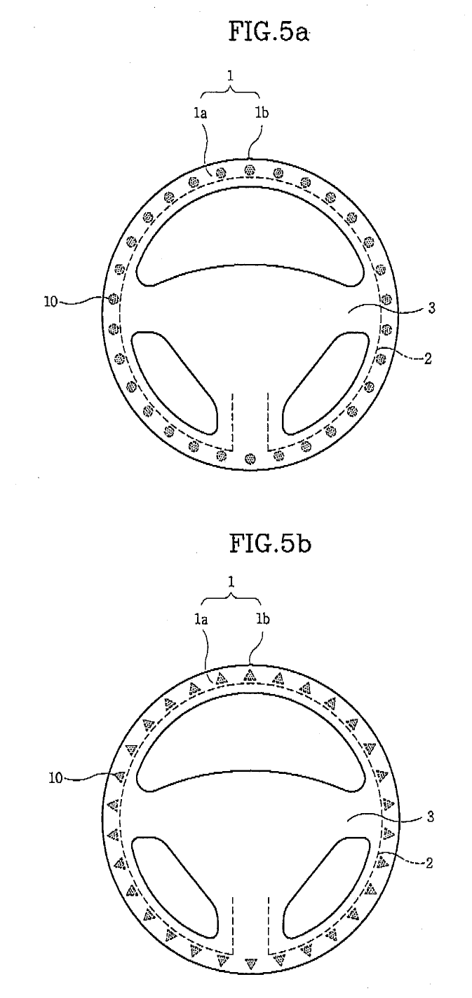

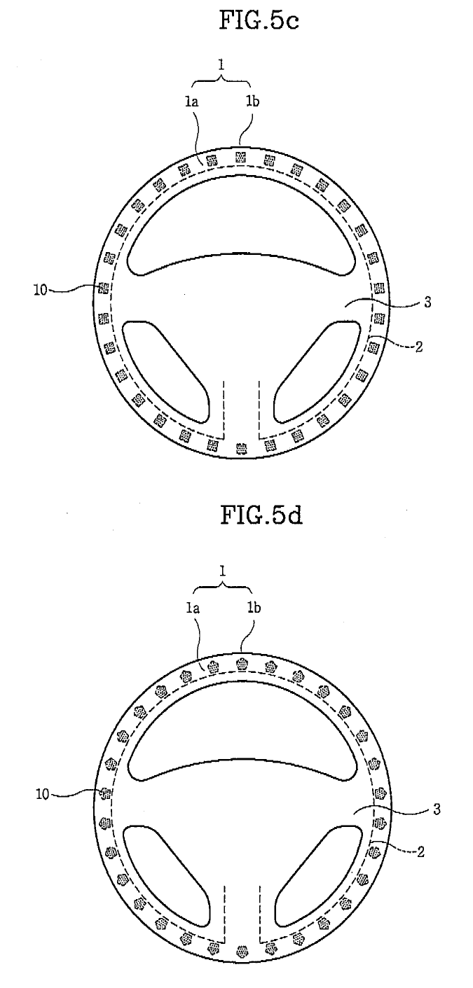

In order to increase the amount of heat generated from ferromagnetic material 10 in the heated steering wheel of the present invention, ferromagnetic material 10, that is, metal powder, may be formed in a circular shape and provided between main body 1a of rim 1 of steering wheel and exterior member 1b, as shown in FIG. 5A. In this case, the pattern of ferromagnetic material 10 is not limited to a circular shape and may be a polygonal shape such as a triangular shape similar to that shown in FIG. 5B, a quadrangular shape similar to that shown in FIG. 5C, or a pentagonal shape similar to that shown in FIG. 5D.

One will appreciate from the foregoing that the conductor is not limited to ferromagnetic material. One will further appreciate that the conductor, and the ferromagnetic material, may include other materials and configurations than metallic powder that can generate an induction current from a change in the magnetic field caused by an alternating electrical current. One will appreciate from the foregoing that the positioning and configuration of the conductor may be further modified in accordance with the present invention.

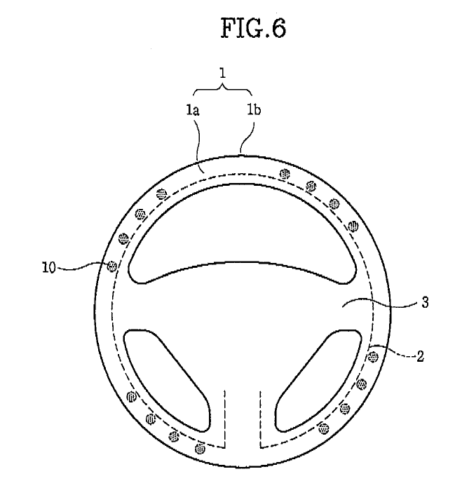

Further, to improve heat generation efficiency of the heated steering wheel of FIG. 6, ferromagnetic material 10 may be provided between main body 1a and exterior member 1b at a rim region 1 of the steering wheel where a driver frequently comes in contact. The ferromagnetic material 10, however, may be omitted from a region in the steering wheel where a spoke 3 and the rim region 1 are joined.

Even in this case, in order to increase the amount of heat generated from ferromagnetic material 10 in the heated steering wheel using induction current according to the present invention, ferromagnetic material 10 may be formed in a circular or polygonal shape between main body 1a of rim 1 and exterior member 1b at a region of rim 1 of steering wheel where a driver frequently comes in contact.

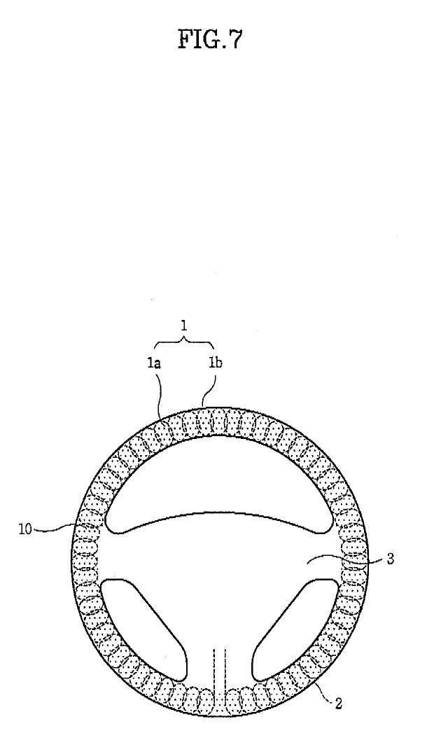

In the heated steering wheel of FIG. 7, conducting member 2 may be provided between main body 1a and exterior member 1b in the same shape as main body 1a along the circumference thereof similar to that shown in FIGS. 3 to 6 described above. Alternatively, conducting member 2 may be wound around the circumference of main body 1a. If conducting member 2 is wound around the main body 1a, a strong magnetic field is generated by the conducting member 2 around rim 1 of steering wheel. Therefore, ferromagnetic material 10 generates a large induction current so that the temperature of rim 1 of steering wheel will quickly rise.

For convenience in explanation and accurate definition in the appended claims, the terms “upper” or “lower”, “front” or “rear”, “inside” or “outside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A heated steering wheel using induction current, the heated steering wheel comprising:
a main body of a steering wheel;
an exterior member that surrounds the main body; and
a conductor provided between the main body and the exterior member, the conductor configured to generate induction current using a change of a magnetic field caused by a supplied alternating current.

2. The heated steering wheel as defined in claim 1, wherein the conductor is composed of a ferromagnetic material.

3. The heated steering wheel as defined in claim 2, wherein the ferromagnetic material is metal powder.

4. The heated steering wheel as defined in claim 1, wherein the conductor is uniformly provided between the main body and the exterior member.

5. The heated steering wheel as defined in claim 4, wherein the conductor is formed in a circular shape along a circumference of the main body.

6. The heated steering wheel as defined in claim 4, wherein the conductor is provided along a circumference of the main body other than a region configured to receive a spoke of the steering wheel.

7. The heated steering wheel as defined in claim 4, wherein the conductor is formed in a polygonal shape.

8. The heated steering wheel as defined in claim 1, further comprising a conducting member provided between the main body and the exterior member, the wire being supplied with alternating current.

9. The heated steering wheel as defined in claim 8, wherein the conducting member is a wire.

10. The heated steering wheel as defined in claim 9, wherein the conducting member is wound around the main body.

11. The heated steering wheel as defined in claim 8, wherein the wire is provided between the main body and the exterior member in a similar shape as the main body.

12. The heated steering wheel as defined in claim 8, wherein the conducting member is provided adjacent the conductor with a predetermined gap therebetween.

13. The heated steering wheel as defined in claim 12, further comprising an insulation member that insulates the conducting member from the conductor.

14. A passenger vehicle comprising the heated steering wheel as defined in claim 1.
